(19) United States
(12) Patent Application Publication
(10) Pub. No.: US 2026/0056749 A1
(43) Pub. Date: Feb. 26, 2026

(54) DEVICE OPERATION METHOD, SYSTEM AND APPARATUS, AND NON-VOLATILE READABLE STORAGE MEDIUM AND ELECTRONIC DEVICE

(71) Applicant: SUZHOU METABRAIN INTELLIGENT TECHNOLOGY CO., LTD., Suzhou, Jiangsu (CN)

(72) Inventors: Bing WANG, Suzhou, Jiangsu (CN); Shuxian WANG, Suzhou, Jiangsu (CN); Fanyi YAO, Suzhou, Jiangsu (CN); Lin YANG, Suzhou, Jiangsu (CN); Zhaonan NING, Suzhou, Jiangsu (CN); Yongbo SUN, Suzhou, Jiangsu (CN); Daotong LI, Suzhou, Jiangsu (CN); Zhaohui LIU, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/103,202

(22) PCT Filed: Nov. 20, 2023
(86) PCT No.: PCT/CN2023/132741

§ 371 Date: Feb. 11, 2025

(30) Foreign Application Priority Data
Mar. 8, 2023 (CN) 202310218225.3

(51) Int. Cl. G06F 9/4401; G06F 11/22; G06F 11/30

(52) U.S. Cl. CPC G06F 9/4401; G06F 11/2284; G06F 11/3051

(57) ABSTRACT

Provided in the embodiments of the present disclosure are a device operation method, system and apparatus, and a non-volatile readable storage medium and an electronic device. The method comprises: during the process of executing a power-on self-test on a server, acquiring a plurality of peripheral devices connected to the server, and memories of expanded memories of respective ones of the plurality of peripheral devices; determining whether the memories of the expanded memories of the plurality of peripheral devices meet a preset memory condition of a basic input output system in the server; when the memories of the expanded memories do not meet the preset memory condition, determining a plurality of candidate device sequences according to the plurality of peripheral devices; and determining a target device sequence from among the plurality of candidate device sequences, and loading and running the multiple target devices in the target device sequence.

### CROSS-REFERENCE TO RELATED APPLICATION

The present application is a National Stage Application of PCT International Application No.: PCT/CN2023/132741 filed on Nov. 20, 2023, which claims priority to Chinese Patent Application 202310218225.3, filed in the China National Intellectual Property Administration on Mar. 8, 2023, the disclosure of which is incorporated herein by reference in its entirety.

### TECHNICAL FIELD

The embodiments of the present disclosure relate to the field of computers, and in particular, to a device operation method, system and apparatus, and a non-volatile readable storage medium and an electronic device.

### BACKGROUND

Servers are key foundational equipment for data storage and services and applications processing, and a Basic Input Output System (BIOS) in a server plays a key role in server systems, such as startup, hardware initialization, and system loading import. With the expansion of the service scale in a large environment, the BIOS system usually uses a traditional startup mode, also known as a Legacy mode, to run key services.

However, in the traditional start-up mode, there are technical limitation bottlenecks such as memory access limitation and resource space insufficiency. During initialization of some peripheral devices, the expanded memories of the devices are loaded into a system memory for running and related processing. However, due to technical limitations, the storage space for processing the expanded memories is fixed. Different sizes of memories may be required for expanded memories of devices mounted to a server, and sometimes the total memory required for the expanded memories of all devices exceeds the specified storage space, resulting in the inability of key devices to be used normally.

Related technologies often avoid such issues by verifying and limiting server configurations in advance, and by manually adjusting the positions of certain types of devices to adjust the loading order of the expanded memories of the devices, so as to achieve rational loading of the expanded memories as far as possible and fully utilize the space. However, manual adjustments may increase time and workload due to repeated plugging and unplugging of cards, and the efficiency is low. Additionally, changes in the types of peripheral devices and the versions of the expanded memories may lead to rework.

For the problem in the related art of it not being possible to use key devices normally due to the fact that the total memory required by the expanded memories exceeds a specified storage space when devices mounted to a server are loaded and run according to the current arrangement order, no effective solution has been proposed at present.

### SUMMARY

The embodiments of the present disclosure provide a device operation method, system and apparatus, and a non-volatile readable storage medium and an electronic device, which may at least solve the problem in the related art of it not being possible to use key devices normally due to the fact that the total memory required by the expanded memories exceeds a specified storage space when devices mounted to a server are loaded and run according to the current arrangement order.

According to an embodiment of the present disclosure, provided is a device operation method, including: during a process of executing power-on self-test on a server, acquiring a plurality of peripheral devices connected to the server, and memories of expanded memories of respective ones of the plurality of peripheral devices; determining whether the memories of the expanded memories of the plurality of peripheral devices meet a preset memory condition of a basic input output system in the server, so as to obtain a determination result; determining a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and determining a target device sequence from among the plurality of candidate device sequences, and loading and running the multiple target devices in the target device sequence.

As an exemplary embodiment, the memories of the expanded memories include running memories, when the determination result indicates that a total running memory of the expanded memories of the plurality of peripheral devices is greater than a first preset value, determining that the memories of the expanded memories of the plurality of peripheral devices do not meet the preset memory condition, wherein the first preset value refers to a size of a memory space supported by the basic input output system in the server.

As an exemplary embodiment, the memories of the expanded memories further include loading memories, and when the determination result indicates that a total running memory of the expanded memories of the plurality of peripheral devices is less than or equal to the first preset value, and the loading memory of a last peripheral device in a current arrangement order of the plurality of peripheral devices is greater than a second preset value, determining that the memories of the expanded memories of the plurality of peripheral devices do not meet the preset memory condition, wherein the first preset value refers to the size of the memory space supported by the basic input output system in the server, and the second preset value is less than the first preset value.

As an exemplary embodiment, before determining whether the memories of the expanded memories of the plurality of peripheral devices meet the preset memory condition of the basic input output system in the server, so as to obtain the determination result, the device operation method further includes: traversing the memories of the expanded memories of the plurality of peripheral devices, to obtain the running memories and the loading memories of respective ones of the plurality of peripheral devices; and summing the running memories of the plurality of peripheral devices to obtain the total running memory of the expanded memories of the plurality of peripheral devices.

As an exemplary embodiment, the memories of the expanded memories include running memories, and when the determination result indicates that the total running memory of the expanded memories of the plurality of peripheral devices is greater than the first preset value, first alarm information is sent.

As an exemplary embodiment, determining the plurality of candidate device sequences according to the plurality of peripheral devices when the determination result indicates that the memories of the expanded memories of the plurality of peripheral devices do not meet the preset memory condition includes: combining at least two peripheral devices among the plurality of peripheral devices multiple times to obtain a plurality of combination results; arranging the devices in each of the plurality of combination results according to different orders, to obtain a plurality of initial device sequences; and screening the plurality of initial device sequences for at least one device sequence that meets a running rule, so as to obtain the candidate device sequences.

As an exemplary embodiment, the running rule includes at least one of the following: the candidate device sequence includes peripheral devices required for running of the server; the candidate device sequence includes peripheral device required by the server for executing a target service; a number of all the multiple target devices in the candidate device sequence is greater than a preset number; and a total running memory of all the multiple target devices in the candidate device sequence is less than or equal to a first preset value, wherein the first preset value refers to a size of a memory space supported by the basic input output system in the server.

As an exemplary embodiment, determining the target device sequence from among the plurality of candidate device sequences includes: respectively calculating a difference value between the first preset value and the total running memory of all the multiple target devices in each of the plurality of candidate device sequences, so as to obtain a plurality of remaining running memories; and determining a candidate device sequence with a maximum remaining running memory as the target device sequence.

As an exemplary embodiment, after arranging the devices in each of the plurality of combination results according to different orders to obtain the plurality of initial device sequences, the device operation method further includes: when there is no device sequence meeting the running rule in the plurality of initial device sequences, sending second alarm information.

As an exemplary embodiment, before determining whether the memories of the expanded memories of the plurality of peripheral devices meet the preset memory condition of the basic input output system in the server, so as to obtain the determination result, the device operation method further includes: determining whether historical device information content check value stored in the basic input output system is 0, and determining whether a total device information content check value of the plurality of peripheral devices is the same as the historical device information content check value; when the historical device information content check value is not 0 and the total device information content check value of the plurality of peripheral devices is the same as the historical device information content check value, loading and running the target device; when the historical device information content check value is 0 or the total device information content check value of the plurality of peripheral devices is different from the historical device information content check value, executing the operation of determining whether the memories of the expanded memories of the plurality of peripheral devices meet the preset memory condition of the basic input output system in the server.

As an exemplary embodiment, before determining whether the total device information content check value of the plurality of peripheral devices is the same as the historical device information content check value, the device operation method further includes: traversing device information contents of the plurality of peripheral devices, and calculating a device information content check value according to the device information content of each of the plurality of peripheral devices, so as to obtain a plurality of device information content check values; and summing the device information content check values of the plurality of peripheral devices to obtain the total device information content check value.

As an exemplary embodiment, after determining whether the historical device information content check value stored in the basic input output system is 0, and determining whether the total device information content check value of the plurality of peripheral devices is the same as the historical device information content check value, the device operation method further includes: when the historical device information content check value is not 0 and the total device information content check value of the plurality of peripheral devices is the same as the historical device information content check value, reading a historical device sequence stored in the basic input output system, wherein the historical device sequence is composed of multiple target devices according to a historical arrangement order; and loading and running the multiple target devices according to the historical device sequence.

As an exemplary embodiment, after determining whether the memories of the expanded memories of the plurality of peripheral devices meet the preset memory condition of the basic input output system in the server, so as to obtain the determination result, the device operation method further includes: when the determination result indicates that the memories of the expansion memories of the plurality of peripheral devices meet the preset memory condition, reading a device sequence stored in the basic input output system, and loading and running the plurality of peripheral devices according to the stored device sequence.

As an exemplary embodiment, loading and running the multiple target devices in the target device sequence includes: summing device information content check values of the multiple target devices to obtain an updated total device information content check value; storing the target device sequence and the updated total device information content check value to the basic input output system; and restarting the server, and loading and running the multiple target devices in the server using the basic input output system.

According to another embodiment of the present disclosure, provided is a device operation system, including: a server; a plurality of peripheral devices connected to the server; and a basic input output system, deployed in the server and configured to, during a process of executing power-on self-test on a server and when memories of expanded memories of a plurality of peripheral devices do not meet a preset memory condition, determine a plurality of candidate device sequences according to the plurality of peripheral devices, determine a target device sequence from among the plurality of candidate device sequences, and load and run multiple target devices in the target device sequence, wherein each of the plurality of candidate device sequences is composed of multiple target devices according to a preset arrangement order, and the multiple target devices are devices in the plurality of peripheral devices.

As an exemplary implementation, the memories of the expanded memories include running memories, the basic input output system is configured to, when a total running memory of the expanded memories of the plurality of peripheral devices is greater than a first preset value, determine that the memories of the expanded memories of the plurality of peripheral devices do not meet the preset memory condition, wherein the first preset value refers to a size of a memory space supported by the basic input output system in the server.

As an exemplary implementation, the memories of the expanded memories include running memories and loading memories, and the basic input output system is configured to, when a total running memory of the expanded memories of the plurality of peripheral devices is less than or equal to a first preset value, and the loading memory of a last peripheral device in a current arrangement order of the plurality of peripheral devices is greater than a second preset value, determine that the memories of the expanded memories of the plurality of peripheral devices do not meet the preset memory condition, wherein the first preset value refers to a size of a memory space supported by the basic input output system in the server, and the second preset value is less than the first preset value.

As an exemplary implementation, the basic input output system is configured to determine the candidate device sequence by: combining at least two peripheral devices among the plurality of peripheral devices multiple times to obtain a plurality of combination results; arranging the devices in each of the plurality of combination results according to different orders, to obtain a plurality of initial device sequences; and screening the plurality of initial device sequences for at least one device sequence that meets a running rule, so as to obtain the candidate device sequences.

According to another embodiment of the present disclosure, provided is an device operation apparatus, including: an acquisition unit, configured to acquire, during a process of executing power-on self-test on a server, a plurality of peripheral devices connected to the server, and memories of expanded memories of respective ones of the plurality of peripheral devices; a first judgment unit, configured to determine whether the memories of the expanded memories of the plurality of peripheral devices meet a preset memory condition of a basic input output system in the server, so as to obtain a determination result; a first determination unit, configured to determine a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and a second determination unit, configured to determine a target device sequence from among the plurality of candidate device sequences, and load and run the multiple target devices in the target device sequence.

According to another embodiment of the present disclosure, further provided is a computer readable storage medium storing a computer program, wherein the computer program is configured to execute, when running, operations in any one of the described method embodiments.

According to another embodiment of the present disclosure, further provided is an electronic device, including a memory and a processor, wherein the memory stores a computer program, and the processor is configured to run the computer program to execute operations in any one of the device operation method.

By means of the present disclosure, when the memories of expanded memories of a plurality of peripheral devices mounted to a server do not meet a preset memory condition, a connection relationship between the peripheral devices and the server is adjusted, an order of the peripheral devices is adjusted, a target device sequence is formed by the adjusted peripheral devices, and devices in the target device sequence are loaded and run, thereby solving the problem in the related art of it not being possible to use key devices normally due to the fact that the total memory required by the expanded memories exceeds a specified storage space when devices mounted to a server are loaded and run according to the current arrangement order, achieving the effect that key devices in the plurality of peripheral devices may be loaded and run, while making maximum use of the memory space of the server.

### BRIEF DESCRIPTION OF THE DRAWINGS

FIG. 1 is a block diagram of the hardware structure of a mobile terminal for implementing a device operation method according to the embodiments of the present disclosure;

FIG. 2 is a schematic diagram of a device operation system according to the embodiments of the present disclosure;

FIG. 3 is a flowchart of a device operation method according to the embodiments of the present disclosure;

FIG. 4 is a flowchart of an exemplary device operation method according to the embodiments of the present disclosure; and

FIG. 5 is a schematic diagram of a device operation apparatus according to the embodiments of the present disclosure.

### DETAILED DESCRIPTION OF THE INVENTION

The embodiments of the present disclosure are described in detail with reference to the accompanying drawings and in conjunction with the embodiments.

It should be noted that, the terms “first”, “second”, etc., in the description, claims and drawings of the present disclosure are used to distinguish similar objects, and do not need to be used to describe a specific order or sequence.

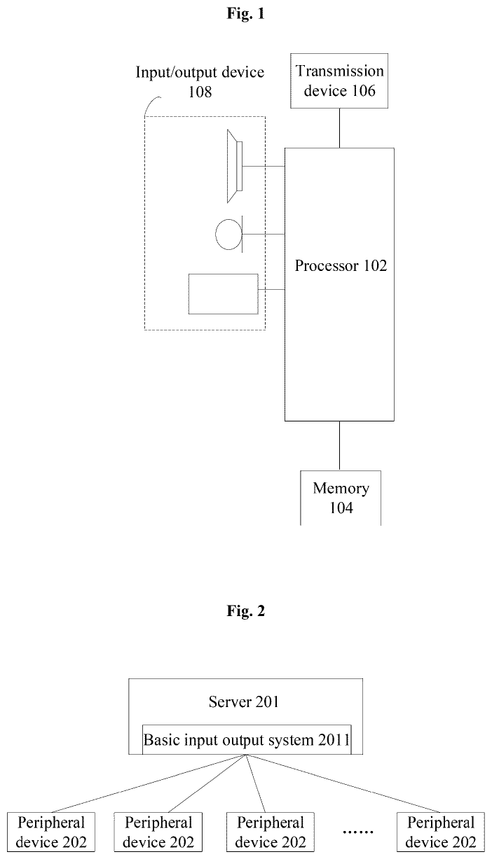

The method embodiment provided in the embodiments of the present disclosure may be executed in a mobile terminal, a computer terminal, or a similar computing device. Taking the implementation on a mobile terminal as an example, FIG. 1 is a block diagram of the hardware structure of a mobile terminal for implementing a device operation method according to the embodiments of the present disclosure. As shown in FIG. 1, the mobile terminal may include one or more (only one is shown in FIG. 1) processors 102 (the one or more processors 102 may include, but are not limited to, a microprocessor (e.g., a Micro Controller Unit (MCU)) or a processing device such as a programmable logic device (e.g., a Field Programmable Gate Array (FPGA)) and a memory 104 configured to store data, wherein the mobile terminal may further include a transmission device 106 for a communication function and an input/output device 108. Those ordinarily skilled in the art may appreciate that the structure shown in FIG. 1 is for illustrative purposes only, but not limit the structure of the mobile terminal. For example, the mobile terminal may also include more or fewer components than that shown in FIG. 1, or have a different configuration than that shown in FIG. 1.

The memory 104 may be configured to store a computer program, for example, a software program and a module of application software, such as a computer program corresponding to the device operation method in the embodiments of the present disclosure. The one or more processors 102 run the computer program stored in the memory 104, so as to execute various function applications and data processing, that is, to implement the foregoing method. The memory 104 may include a high-speed random access memory, and may also include a non-transitory memory, such as one or more magnetic storage apparatuses, flash memories, or other non-transitory solid-state memories. In some instances, the memory 104 may include memories remotely arranged with respect to the one or more processors 102, and these remote memories may be connected to the mobile terminal over a network. Examples of the network above includes, but is not limited to, an Internet, intranets, a local area network, a mobile communication network, and combinations thereof.

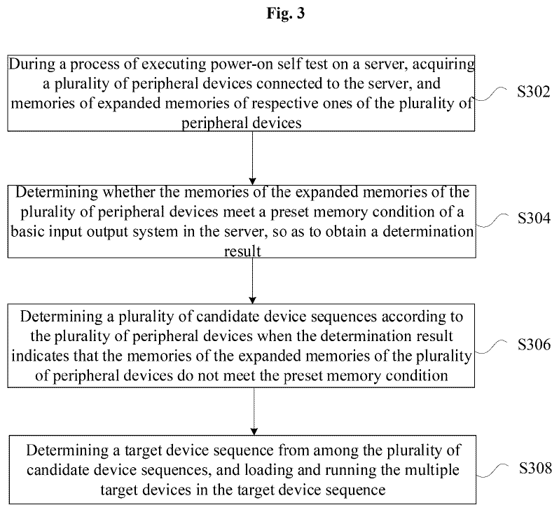

The transmission device 106 is configured to receive or transmit data by a network. Optional examples of the described network may include a wireless network provided by a communication provider of the mobile terminal. In one example, the transmission device 106 includes a Network Interface Controller (NIC) which may be connected to other network devices by means of a base station, thereby being able to communicate with the Internet. In one example, the transmission device 106 may be a Radio Frequency (RF) module for communicating wirelessly with the Internet. The present embodiment provides a device operation system. FIG. 2 is a schematic diagram of a device operation system according to the embodiments of the present disclosure. As shown in FIG. 2, the device operation system includes:
a server 201;
a plurality of peripheral devices 202 connected to the server 201,
wherein as an exemplary implementation, the plurality of peripheral devices 202 may be PCIE devices, that is, devices supported by Peripheral Component Interconnect express (PCI-Express), and the plurality of peripheral devices 202 are mounted to the server 201 according to a certain arrangement order; and
a basic input output system 2011 deployed in the server 201 and configured to, during a process of executing power-on self-test on the server 201 and when the memories of the expanded memories of the plurality of peripheral devices 202 do not meet the preset memory condition, determine a plurality of candidate device sequences according to the plurality of peripheral devices 202, determine a target device sequence from among the plurality of candidate device sequences, and load and run the multiple target devices in the target device sequence, wherein each of the plurality of candidate device sequences is composed of multiple target devices according to a preset arrangement order, and the multiple target devices are devices in the plurality of peripheral devices 202.

As an exemplary implementation, the basic input output system 2011 is deployed on the server 201, and determines, when the server 201 executes a power-on self-test operation, whether devices connected to the server 201 are able to normally run in a memory condition of the server according to a current arrangement order, i.e., determining whether the memories of expanded memories of the plurality of peripheral devices 202 meet a preset memory condition. When the memories of the expanded memories of the plurality of peripheral devices 202 do not meet the preset memory condition, that is, when the plurality of peripheral devices 202 cannot run in the memory condition of the server according to the current arrangement order, the basic input output system 2011 selects a plurality of candidate devices from all the peripheral devices 202 to constitute a plurality of candidate device sequences, screens the plurality of candidate device sequences according to a certain standard to obtain a single target device sequence, and loads and runs all target devices in the target device sequence according to the target device sequence to complete a specific job.

The preset memory condition of the basic input output system 2011 is a condition used to determine whether the plurality of peripheral devices 202 fail to run normally due to abnormality in memory space. As an exemplary implementation, the memories occupied by the expanded memories in the plurality of peripheral devices 202 need to be determined, i.e., determining whether the running memory parameter values of the expanded memories in the plurality of peripheral devices 202 meet the preset memory condition, so as to obtain a determination result. The plurality of peripheral devices 202, when running, will load expanded memories therein into the memory of the server 201 to perform a relevant processing operation, however, due to the limitations of the system itself, there is only a certain amount of memory that is able to process the expanded memories, and therefore, it is required to determine whether the memories of the expanded memories of the plurality of peripheral devices 202 meet the preset memory condition.

For example, the sum of the memory space sizes occupied by the plurality of peripheral devices 202 that are able to be supported by the basic input output system 2011 in the server 201 in the legacy startup mode is 128K bytes, the memories of the expanded memories include running memories and loading memories, and the preset memory condition may refer to a condition that the sum of the running memories of the expanded memories of the plurality of peripheral devices 202 is less than or equal to 128K bytes, and the loading memory of the last peripheral device 202 is less than a set value.

As an exemplary implementation, in the device operation system provided in the embodiments of the present disclosure, the memories of the expanded memories include running memories, when the total running memory of the expanded memories of the plurality of peripheral devices 202 is greater than a first preset value, the basic input output system 2011 determines that the memories of the expanded memories of the plurality of peripheral devices 202 do not meet the preset memory condition, wherein the first preset value refers to the size of a memory space supported by the basic input output system 2011 in the server 201.

As an exemplary implementation, the memories of the expanded memory assemblies of the plurality of peripheral devices 202 may include running memories. A situation that the memories of the expanded memories of the plurality of peripheral devices 202 do not meet the preset memory condition may refer to a situation that the total running memory of the expanded memories of the plurality of peripheral devices 202 is greater than the first preset value, wherein the first preset value refers to the sum of the memory space sizes occupied by the plurality of peripheral devices 202 that are able to be supported by the basic input output system 2011 in the legacy startup mode, for example, the first preset value may be 128K bytes.

For example, five peripheral devices 202 are connected outside the server 201, and a device sequence is formed by the five devices. when the memories of the expanded memories of the five devices do not meet a preset memory condition, i.e., when the total running memory of the five devices may be greater than the first preset value, the data of the total running memory is recorded as X bytes, that is, when X>128, the preset memory condition is not met.

As an exemplary implementation, in the device operation system provided by the embodiment of the present disclosure, the memories of the expanded memories include running memories and loading memories, and when the total running memory of the expanded memories of the plurality of peripheral devices 202 is less than the first preset value, and when the loading memory of the last peripheral device 202 in the current arrangement order of the plurality of peripheral devices 202 is greater than a second preset value, it is determined that the memories of the expanded memories of the plurality of peripheral devices 202 do not meet the preset memory condition, wherein the first preset value refers to the size of a memory space supported by the basic input output system 2011 in the server 201, and the second preset value being less than the first preset value.

As an exemplary implementation, the memories of the expanded memory assemblies may include running memories and loading memories, and the size of the running memory is less than the size of the loading memory. The memories of the expanded memories of the plurality of peripheral devices 202 do not meet the preset memory condition, which may also represent the situation that when the total running memory of the expanded memories of the plurality of peripheral devices 202 is less than or equal to the first preset value and when the plurality of peripheral devices 202 forms a default sequence, the loading memory of the last peripheral device 202 in the sequence is greater than a difference value between the first preset value and the sum of the running memories of other devices other than the last device.

As an exemplary implementation, the memories of the expanded memory assemblies may include running memories and loading memories. It should be noted that, when each peripheral device 202 starts working, the device needs to be loaded to a specific area first, and the device is able to work normally only after being loaded; therefore, the size parameter of the loading memory is greater than the size parameter of the running memory.

The memories of the expanded memories of the plurality of peripheral devices 202 do not meet the preset memory condition, which may also represent the situation that when the total running memory of the expanded memories of the plurality of peripheral devices 202 is less than or equal to the first preset value and when the plurality of peripheral devices 202 forms a default sequence, the loading memory of the last peripheral device 202 is greater than a second preset value, wherein the second preset value may be a difference value between the first preset value and the sum of the running memories of other devices other than the last device.

For example, five peripheral devices 202 are connected outside the server 201, and a device sequence is formed by the five devices; when memories of the expanded memories of the five devices do not meet a preset memory condition, the condition may also refer to that the total running memory of the five devices is less than or equal to the first preset value, the data of the total running memory is recorded as X bytes, that is, when X<=128, the loading memory of the fifth device in the sequence is greater than the difference between the first preset value and the total running memory of the first four devices, the size of the loading memory is recorded as Z bytes, and the size of the total running memory of the first four devices is recorded as Y bytes, i.e., “Z>128−Y”.

As an exemplary implementation, in the device operation system provided in the embodiment of the present disclosure, the basic input output system 2011 determines the candidate device sequence by: combining at least two peripheral devices 202 among the plurality of peripheral devices 202 multiple times to obtain a plurality of combination results; arranging the devices in each of the plurality of combination results according to different orders, to obtain a plurality of initial device sequences; and screening the plurality of initial device sequences for at least one device sequence that meets a running rule, so as to obtain the candidate device sequences.

As an exemplary implementation, when the total running memory of the expanded memories do not meet the preset memory condition, multiple target devices need to be selected from the plurality of peripheral devices 202 connected to the server 201 to form the candidate device sequence, as an exemplary implementation, two or more devices are selected from the plurality of peripheral devices 202 multiple times to perform a combination operation to obtain all possible combination results, and devices in all the combination results are arranged according to different orders to obtain a plurality of sequences, for example, two devices, denoted as device A and device B, are selected from five devices, the device A and the device B are arranged in different orders, i.e., in the order of AB or BA, or three devices, denoted as device A, device B and device C, are selected from five devices, the three devices are arranged in different orders and may be arranged and combined in six orders, i.e., ABC, ACB, BAC, BCA, CAB and CBA.

Further, all the obtained sequences are screened by a certain running rule to select a candidate device sequence.

By means of the above system which includes the server 201, the plurality of peripheral devices 202 connected to the server 201, and the basic input output system 2011, deployed in the server 201 and configured to, during the process of executing power-on self-test on the server 201 and when the memories of the expanded memories of the plurality of peripheral devices 202 do not meet the preset memory condition, determine a plurality of candidate device sequences according to the plurality of peripheral devices, determine a plurality of candidate device sequences according to a plurality of peripheral devices 202, determine a target device sequence from among the plurality of candidate device sequences, and load and run the multiple target devices in the target device sequence, wherein each of the plurality of candidate device sequences is composed of multiple target devices according to a preset arrangement order, and the multiple target devices are devices in the plurality of peripheral devices 202, it solves the problem in the related art of it not being possible to use key devices normally due to the fact that the total memory required by the expanded memories exceeds a specified storage space when devices mounted to a server are loaded and run according to the current arrangement order, achieving the effect that key devices in the plurality of peripheral devices may be loaded and run, while making maximum use of the memory space of the server.

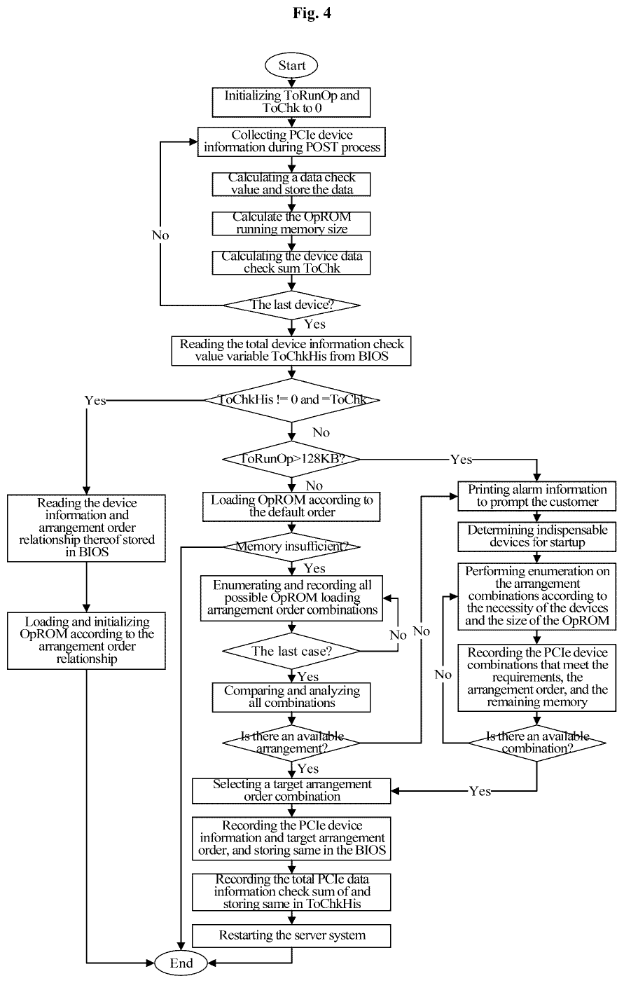

The present embodiment provides a method run in the device operation system. FIG. 3 is a flowchart of a device operation method according to the embodiments of the present disclosure. As shown in FIG. 3, the device operation method includes the following operations:

In operation S302: during a process of executing power-on self-test on a server, a plurality of peripheral devices connected to the server, and memories of expanded memories of respective ones of the plurality of peripheral devices are acquired.

As an exemplary implementation, the peripheral devices are connected to the server in a certain arrangement order, and the peripheral devices may be PCIE devices, i.e., Devices supported by peripheral component interconnect express (PCI-Express), wherein PCI-Express is a high-speed serial computer expansion bus standard, peripheral devices include a plurality of assemblies, and the assemblies may be an expanded read-only memory (i.e., OpROM); when the peripheral devices are initialized, the OpROMs of these devices are loaded into a memory for running and related processing, the peripheral devices may include a VGA, a Model 9271 RAID card, a Model 1350 network card, a Model #82599 network card, a Model #x520 network card, etc., When peripheral devices need to be loaded and run, the peripheral devices are started in sequence according to the sequence, and the OpROMs of the peripheral devices have a memory requirement for the server.

When it is required to verify whether the devices connected to the server fail to run normally due to abnormality in memory space caused by a configuration sequence problem, first, a power-on self-test operation needs to be performed on the server, and during the power-on self-test operation, the basic input output system stored on the server is used to acquire the peripheral devices connected to the server and the memory data of the expanded memories in the peripheral devices, so as to determine the occupied memory space.

In operation S304: it is determined whether the memories of the expanded memories of the plurality of peripheral devices meet a preset memory condition of the basic input output system in the server, so as to obtain a determination result.

The preset memory condition of the basic input output system is a condition used to determine whether the peripheral devices fail to run normally due to abnormality in memory space, as an exemplary implementation, the memories occupied by the expanded memories in the plurality of peripheral devices need to be determined, i.e., determining whether the running memory parameter values of the expanded memories in the peripheral devices meet the preset memory condition, so as to obtain a determination result, wherein the peripheral devices, when running, will load expanded memories therein into the memory of the server to perform a relevant processing operation, however, due to the limitations of the system itself, there is only a certain amount of memory that is able to process the expanded memories, and therefore, it is required to determine whether the memories of the expanded memories of the plurality of peripheral devices meet the preset memory condition.

For example, the sum of the memory space occupied by the peripheral devices that are able to be supported by the basic input output system in the server in the legacy startup mode is 128K bytes, the memories of the expanded memories include running memories and loading memories, and the preset memory condition may refer to a condition that the sum of the running memories of the expanded memories of the plurality of peripheral devices is less than or equal to 128K bytes, and the loading memory of the last peripheral device is less than a set value.

In operation S306: a plurality of candidate device sequences are determined according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices.

As an exemplary implementation, when the determination result indicates that the running memories of the plurality of peripheral devices are greater than 128K bytes, or the loading memory of the last peripheral device is greater than the set value, some devices need to be selected from all the peripheral devices as target devices, and these target devices are arranged according to a specific arrangement order to obtain a candidate device sequence, so that when the candidate device sequence runs, all the multiple target devices in the sequence are able to run normally.

In operation S308: a target device sequence is determined from among the plurality of candidate device sequences, and the multiple target devices in the target device sequence are loaded and run.

As an exemplary implementation, the target device sequence is a candidate device sequence, that best matches the selection standard, among the plurality of candidate device sequences, for example, the selection standard may be a candidate device sequence with the maximum remaining memory of the running server, the selection standard may also be a candidate device sequence including the maximum number of specified devices, and a target device sequence is determined from the plurality of device sequences, then, the target device is loaded and run to the server according to the device sequence, to complete the set task.

By means of the described operations: during a process of executing power-on self-test on a server, acquiring a plurality of peripheral devices connected to the server, and memories of expanded memories of respective ones of the plurality of peripheral devices; determining whether the memories of the expanded memories of the plurality of peripheral devices meet a preset memory condition of a basic input output system in the server, so as to obtain a determination result; determining a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and determining a target device sequence from among the plurality of candidate device sequences, and loading and running the multiple target devices in the target device sequence, it solves the problem in the related art of it not being possible to use key devices normally due to the fact that the total memory required by the expanded memories exceeds a specified storage space when devices mounted to a server are loaded and run according to the current arrangement order, achieving the effect that key devices in the plurality of peripheral devices may be loaded and run, while making maximum use of the memory space of the server.

An execution subject of the described operations may be a base station, a terminal, etc., but is not limited thereto.

The execution order of operation S304 and operation S306 may be interchanged, that is, operation S306 may be executed first, and then operation S304 is executed.

As an exemplary implementation, in the device operation method provided in the embodiment of the present disclosure, the memories of the expanded memories include running memories, when the determination result indicates that a total running memory of the expanded memories of the plurality of peripheral devices is greater than a first preset value, it is determined that the memories of the expanded memories of the plurality of peripheral devices do not meet the preset memory condition, wherein the first preset value refers to a size of a memory space supported by the basic input output system in the server.

As an exemplary implementation, the memories of the expanded memory assemblies of the peripheral devices may include running memories. A situation that the memories of the expanded memories of the peripheral devices do not meet the preset memory condition may refer to a situation that the total running memory of the expanded memories of the peripheral devices is greater than the first preset value, wherein the first preset value refers to the sum of the memory space occupied by the peripheral devices that are able to be supported by the basic input output system in the legacy startup mode, for example, the first preset value may be 128K bytes.

For example, five peripheral devices are connected outside the server, and a device sequence is formed by the five devices. When the memories of the expanded memories of the five devices do not meet a preset memory condition, i.e., when the total running memory of the five devices is greater than the first preset value, the data of the total running memory is recorded as X bytes, that is, when X>128, the preset memory condition is not met.

As an exemplary implementation, in the device operation method provided in the embodiments of the present disclosure, the memories of the expanded memories further include loading memories, and when the determination result indicates that a total running memory of the expanded memories of the plurality of peripheral devices is less than or equal to the first preset value, and the loading memory of a last peripheral device in a current arrangement order of the plurality of peripheral devices is greater than a second preset value, determining that the memories of the expanded memories of the plurality of peripheral devices do not meet the preset memory condition, wherein the first preset value refers to the size of the memory space supported by the basic input output system in the server, and the second preset value is less than the first preset value.

As an exemplary implementation, the memories of the expanded memory assemblies may include running memories and loading memories. It should be noted that, when each peripheral device starts working, the device needs to be loaded to a specific area first, and the device is able to work normally only after being loaded; therefore, the size parameter of the loading memory is greater than the size parameter of the running memory.

The memories of the expanded memories of the plurality of peripheral devices do not meet the preset memory condition, which may also represent the situation that when the total running memory of the expanded memories of the peripheral devices is less than or equal to the first preset value and when the peripheral devices forms a default sequence, the loading memory of the last peripheral device is greater than a second preset value, wherein the second preset value may be a difference value between the first preset value and the sum of the running memories of other devices other than the last device.

For example, five peripheral devices are connected outside the server, and a device sequence is formed by the five devices; when memories of the expanded memories of the five devices do not meet a preset memory condition, the condition may also refer to that the total running memory of the five devices is less than or equal to the first preset value, the data of the total running memory is recorded as X bytes, that is, when X<=128, the loading memory of the fifth device in the sequence is greater than the difference between the first preset value and the total running memory of the first four devices, the size of the loading memory is recorded as Z bytes, and the size of the total running memory of the first four devices is recorded as Y bytes, i.e., “Z>128−Y”.

As an exemplary implementation, in the device operation method provided in the embodiments of the present disclosure, before determining whether the memories of the expanded memories of the plurality of peripheral devices meet the preset memory condition of the basic input output system in the server, so as to obtain the determination result, the device operation method further includes: traversing the memories of the expanded memories of the plurality of peripheral devices, to obtain the running memories and the loading memories of respective ones of the plurality of peripheral devices; and summing the running memories of the plurality of peripheral devices to obtain the total running memory of the expanded memories of the plurality of peripheral devices.

Before determining whether the memories of the expanded memories meet the preset memory condition, the total running memory size of the expanded memories needs to be calculated first, as an exemplary implementation, is required to first traverse all peripheral devices connected to the server according to the connection device table stored in the server, then initialize the numerical value of the total running memory of all peripheral devices, i.e., set the numerical value of an initial total running memory as 0, and collect device information about each peripheral device, for example, collect the running memory information and loading memory information, device serial numbers, device identification codes, firmware versions, etc., of the expanded memories.

Every time a peripheral device is traversed, the running memory of the peripheral device and the initial total running memory are summed to obtain a total memory; and when a second peripheral device is traversed, the running memory of the peripheral device and the previous total memory are continued to be summed until all the peripheral devices are traversed, to obtain the total running memory of the expanded memories of the plurality of peripheral devices.

As an exemplary implementation, in the device operation method provided in the embodiments of the present disclosure, the memories of the expanded memories include running memories, and when the determination result indicates that the total running memory of the expanded memories of the plurality of peripheral devices is greater than the first preset value, first alarm information is sent.

As an exemplary implementation, when the total running memory of the expanded memories of the peripheral devices is greater than 128K bytes, before the target device is screened out from all the peripheral devices, alarm information needs to be sent first, so as to prompt the developer to pay attention to the sequential updating of the devices.

As an exemplary implementation, in the device operation method provided in the embodiments of the present disclosure, determining the plurality of candidate device sequences according to the plurality of peripheral devices when the determination result indicates that the memories of the expanded memories of the plurality of peripheral devices do not meet the preset memory condition includes: combining at least two peripheral devices among the plurality of peripheral devices multiple times to obtain a plurality of combination results; arranging the devices in each of the plurality of combination results according to different orders, to obtain a plurality of initial device sequences; and screening the plurality of initial device sequences for at least one device sequence that meets a running rule, so as to obtain the candidate device sequences.

When the total running memory of the expanded memories do not meet the preset memory condition, multiple target devices need to be selected from the plurality of peripheral devices connected to the server to form the candidate device sequence, as an exemplary implementation, two or more devices are selected from the plurality of peripheral devices multiple times to perform a combination operation to obtain all possible combination results, and devices in all the combination results are arranged according to different orders to obtain a plurality of sequences, for example, two devices, denoted as device A and device B, are selected from five devices, the device A and the device B are arranged in different orders, i.e., in the order of AB or BA, or three devices, denoted as device A, device B and device C, are selected from five devices, the three devices are arranged in different orders and may be arranged and combined in six orders, i.e., ABC, ACB, BAC, BCA, CAB and CBA.

Further, all the obtained sequences are screened by a certain running rule to select a candidate device sequence.

As an exemplary implementation, in the device operation method provided in the embodiments of the present disclosure, the running rule includes at least one of the following: the candidate device sequence includes peripheral devices required for running of the server; the candidate device sequence includes peripheral device required by the server for executing a target service; a number of all the multiple target devices in the candidate device sequence is greater than a preset number; and a total running memory of all the multiple target devices in the candidate device sequence is less than or equal to a first preset value, wherein the first preset value refers to a size of a memory space supported by the basic input output system in the server.

As an exemplary implementation, there may be a plurality of running rules, for example, rule 1 may be whether the devices in the sequence include the peripheral devices required for running of the server, i.e., whether including devices indispensable devices for the running of the server, such as a Video Graphics Array (VGA), when there is no indispensable device in a certain arrangement order, the sequence is a sequence that does not meet the rule and needs to be discarded.

Rule 2 may be whether the devices in the sequence include a device necessary for the target service, that is, whether a specific device specified by a manufacturer is included, and if a certain sequence does not include the specific device specified by the manufacturer, the device needs to be discarded.

Rule 3 may be whether the number of devices in the sequence is greater than a preset number, wherein the preset number may be half the number of all peripheral devices, that is, the number of devices in the sequence needs to be greater than half the number of all devices.

Rule 4 may be that the total running memory of the devices in the sequence needs to be less than 128K bytes, that is, the devices included in the sequence may run normally under the memory condition of the server.

As an exemplary implementation, in the device operation method provided in the embodiments of the present disclosure, determining the target device sequence from among the plurality of candidate device sequences includes: respectively calculating a difference value between the first preset value and the total running memory of all the multiple target devices in each of the plurality of candidate device sequences, so as to obtain a plurality of remaining running memories; and determining a candidate device sequence with a maximum remaining running memory as the target device sequence.

When a plurality of candidate device sequences all meeting the plurality of running rules are obtained, a target device sequence may be screened according to the size of the remaining memory space, as an exemplary implementation, the total running memory of all target devices in each of the plurality of candidate device sequences is calculated, that is, the running memories of all devices are summed to obtain a total memory, and a subtraction operation is performed on the total running memory and the first preset value to obtain a memory difference value, i.e., remaining running memories, wherein a plurality of remaining running memories are sequenced in a descending order, and a candidate device sequence with the maximum remaining running memory is determined as a target device sequence, that is, the candidate device sequence corresponding to the first position in the descending arrangement is determined as the target device sequence.

As an exemplary implementation, in the device operation method provided in the embodiments of the present disclosure, after arranging the devices in each of the plurality of combination results according to different orders to obtain the plurality of initial device sequences, the device operation method further includes: when there is no device sequence meeting the running rule in the plurality of initial device sequences, sending second alarm information.

As an exemplary implementation, in cases where the plurality of sequences obtained by arranging the devices in the combination result according to different orders do not meet the running, that is, when there is no candidate device sequence meeting the running rule, second alarm information needs to be sent to prompt the developer to pay attention.

As an exemplary implementation, in the device operation method provided in the embodiments of the present disclosure, before determining whether the memories of the expanded memories of the plurality of peripheral devices meet the preset memory condition of the basic input output system in the server, so as to obtain the determination result, the device operation method further includes: determining whether historical device information content check value stored in the basic input output system is 0, and determining whether a total device information content check value of the plurality of peripheral devices is the same as the historical device information content check value; when the historical device information content check value is not 0 and the total device information content check value of the plurality of peripheral devices is the same as the historical device information content check value, loading and running the target device; when the historical device information content check value is 0 or the total device information content check value of the plurality of peripheral devices is different from the historical device information content check value, executing the operation of determining whether the memories of the expanded memories of the plurality of peripheral devices meet the preset memory condition of the basic input output system in the server.

Before determining whether the total running memory of the devices meets the preset memory condition, it is required to first determine whether the sequence, types, and quantity of the devices have been changed before the current power-on self-test process, that is, it is required to compare with the historical device sequence and the historical devices. As an exemplary implementation, the historical device information content check value stored in the basic input output system is acquired, and it is determined whether the historical device information content check value is 0; when the historical device information content check value is 0, it indicates that the historical devices and the historical device sequence are not stored, that is, the current power-on self-test operation is a first power-on self-test operation of the server.

When the historical device information content check value is not 0, it is determined that the historical device information content check value is the same as the total device information content check value of all the devices performing the current power-on self-testing process, and when the two check values are the same, it indicates that the devices and the device sequence in this test have not been changed. When the two check values are different and the check value of the historical device information content is not 0, it is further determined whether the total running memory of the devices meets the preset memory condition.

It should be noted that, each device information content check value is used to represent a check value calculated by all device information of one peripheral device connected to the server, such as a check value calculated according to the running memory information and loading memory information, device serial number, device identification code and firmware version of the device; each peripheral device has a unique device information content check value, and if the device information content check values of the two devices are the same, it indicates that the two devices are the same peripheral devices, and the loading memories and the running memories of the devices are the same in size.

As an exemplary implementation, in the device operation method provided in the embodiments of the present disclosure, after determining whether the historical device information content check value stored in the basic input output system is 0, and determining whether the total device information content check value of the plurality of peripheral devices is the same as the historical device information content check value, the device operation method further includes: when the historical device information content check value is not 0 and the total device information content check value of the plurality of peripheral devices is the same as the historical device information content check value, reading a historical device sequence stored in the basic input output system, wherein the historical device sequence is composed of multiple target devices according to a historical arrangement order; and loading and running the multiple target devices according to the historical device sequence.

As an exemplary implementation, after the total device information content check value of the current power-on self-test operation is obtained by calculation, the value is compared with the historical device information content check value, when the total device information content check value is the same as the historical device information content check value, it indicates that the device and the device sequence in this test are not changed, the arrangement order of historical devices stored in the basic input output system in the server is read, and then all target devices in this operation are loaded and run according to the stored historical device order, thereby improving the loading and running efficiency.

As an exemplary implementation, in the device operation method provided in the embodiments of the present disclosure, after determining whether the memories of the expanded memories of the plurality of peripheral devices meet a preset memory condition of a basic input output system in the server to obtain a determination result, the device operation method further includes: when the determination result indicates that the memories of the expansion memories of the plurality of peripheral devices meet the preset memory condition, reading a device sequence stored in the basic input output system, and loading and running the plurality of peripheral devices according to the stored device sequence.

As an exemplary implementation, when the determination result indicates that the total running memory of all peripheral devices connected to the server is less than or equal to 128K bytes; when the loading memory of the last peripheral devices in the stored arrangement order is less than the set value, all peripheral devices connected to the server are arranged according to an arrangement order stored in the basic input output system; and the arranged devices are loaded and run.

As an exemplary implementation, in the device operation method provided by the embodiments of the present disclosure, before determining whether the total device information content check value of the plurality of peripheral devices is the same as the historical device information content check value, the device operation method further includes: traversing device information contents of the plurality of peripheral devices, and calculating a device information content check value according to the device information content of each of the plurality of peripheral devices to obtain a plurality of device information content check values; and summing the device information content check values of the plurality of peripheral devices to obtain the total device information content check value.

As an exemplary implementation, after the device information of each device is acquired, the device information content check value of each device may be calculated according to a specific encryption algorithm, that is, each device corresponds to a unique device information content check value. Before traversing the peripheral devices of the basic input output system, an initialization operation is performed on the total device information content check values of all devices, that is, the initial total device information content check value is set to 0, and then the traversing operation is performed.

When the first device is traversed, the device information content check value of the first device and the initial total device information content check value are summed; every time one device is traversed, the device information content check value of the device and the device information content check values of all the devices already traversed are summed; and finally the total device information content check value is obtained.

As an exemplary implementation, in the device operation method provided in the embodiments of the present disclosure, loading and running the multiple target devices in the target device sequence includes: summing device information content check values of the multiple target devices to obtain an updated total device information content check value; storing the target device sequence and the updated total device information content check value to the basic input output system; and restarting the server, and loading and running the multiple target devices in the server using the basic input output system.

As an exemplary implementation, after the multiple target devices and the target device sequence are obtained by screening, before the running of the multiple target devices, the device information content check value needs to be calculated according to the device information of each target device, then a plurality of device information content check values are summed to obtain a total device information content check value, and the total device information content check value and the target device sequence are stored into the basic input output system, the reference data is provided for changing the device sequence subsequently, and furthermore, the server is restarted, so that the device may be loaded and run by means of the system.

From the description of the described embodiments, a person skilled in the art would have been able to clearly understand that the device operation method in the described embodiments may be implemented by using software and necessary general hardware platforms, and of course may also be implemented using hardware, but in many cases, the former is a better embodiment. Based on such understanding, the essence of technical solution of the embodiments of the present disclosure, or in other words, the part of the technical solutions making contributions to the related art, may be embodied in the form of a software product stored in a non-volatile readable storage medium (such as a Read-Only Memory (ROM)/Random Access Memory (RAM), a magnetic disk and an optical disc), including a number of instructions for enabling a terminal device (which may be a mobile phone, a computer, a server, or a network device, etc.) to perform the device operation methods described in various embodiments of the present disclosure.

The present embodiment further provides an exemplary device operation method. FIG. 4 is a flowchart of an exemplary device operation method according to the embodiments of the present disclosure. As shown in FIG. 4, the device operation method includes:
when a power-on self-test operation is performed on the server, acquiring a plurality of peripheral devices connected to the server, device information of all the peripheral devices, and a memory of an expanded memory of each peripheral device; and performing an initialization operation on the running memory capacities and data information check values of the expanded memories of all the peripheral devices;
traversing all peripheral devices, and calculating a data check value ToChk of the peripheral device and a total running memory ToRunOp of the device by means of the initialized check value and device information; determining whether all the peripheral devices are traversed, and if not traversed completely, performing traversal according to a device table stored in the system until it is traversed completely;
after all peripheral devices are acquired, determining whether the order of the peripheral devices has been changed, and first acquiring a device information total check value variable ToChkHis stored in the system; and when the device information total check value variable is consistent with a current check value, regarding that the order has not changed, directly reading the devices and arrangement order thereof stored in the system, and loading and initializing the devices according to the arrangement order;
when the arrangement order of the peripheral devices changes, that is, the two check values are different, determining whether the ToRunOp is greater than a memory space limit that is able to be supported by the system, that is, whether the ToRunOp is greater than 128KB;
if the ToRunop is less than 128KB, loading and initializing the devices according to a default arrangement order, and then determining whether there is a situation that the loading memory of the devices is not enough, and when the loading memory is enough, directly determining the order as a target sequence and determining the devices as target devices;
when the loading memory is not enough, that is, the total running memory of the expanded memories of the peripheral devices is less than or equal to 128 KB, when the peripheral devices form a default order, and when the loading memory of the last peripheral device is greater than a total difference value between the first preset value and the total running memory of other devices other than the last device, firstly enumerating a combination of arrangement orders of all the devices, and detecting whether the enumeration is completed, and if the enumeration is not completed, performing traversal enumeration according to the stored combination table; after all combinations are enumerated, recording whether there is a case of insufficient memory loading in each case, and the size and quantity of the remaining memory space; and after recording, comparing and analyzing all the combinations according to a running rule, for example, the running rule may be rule 1, and may be whether the devices in a sequence include peripheral devices required for running of the server, and whether devices in the sequence include devices necessary for a target service, etc.; if it is determined that there is a combination order complying with the requirements, screening all the combinations, selecting a combination with the maximum remaining space, and taking the combination as a target sequence and target devices; if it is determined that there is no combination complying with the requirements, firstly printing alarm information for a client to make reference, and determining devices indispensable for starting this time, and then screening and enumerating the arrangement combinations according to the necessity of the devices and the size of the occupied memory space, selecting combinations satisfying requirements according to a running rule, and recording the arrangement orders and remaining space sizes thereof, then screening the combinations, and selecting a combination with the maximum remaining space as the target sequence and the target combination;
if it is determined that the ToRunop is greater than a memory space limit that is able to be supported by the system, printing alarm information for a client to make reference, and determining devices indispensable for starting this time, and then screening and enumerating the arrangement combinations according to the necessity of the devices and the size of the occupied memory space, selecting combinations satisfying requirements according to a running rule, and recording the arrangement orders and remaining space sizes thereof, determining whether there is an available combination, and if there is no combination complying with the requirements, screening again according to the necessity of the devices and the size of the occupied memory space, until selecting combinations complying with the requirements; then screening the combinations complying with the requirements, and selecting a combination with the maximum remaining space as a target sequence and a target combination;
calculating check values according to device information of the devices, and storing the check values and the obtained target sequence and target devices into a system, so that the devices may be loaded and run normally.

The present embodiment also provides a device operation apparatus, and the apparatus is configured to implement the foregoing embodiments and optional implementations, which has been described and will not be described repeatedly here. As used below, the term “unit” may implement a combination of software and/or hardware of predetermined functions. Although the apparatus described in the following embodiments is preferably implemented in software, implementation in hardware or a combination of software and hardware is also possible and conceived.

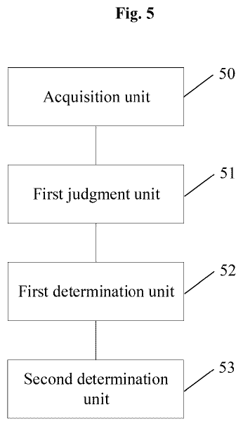

FIG. 5 is a schematic diagram of a device operation apparatus according to the embodiments of the present disclosure. As shown in FIG. 5, the apparatus includes: an acquisition unit 50, a first judgment unit 51, a first determination unit 52, and a second determination unit 53;
the acquisition unit 50 is configured to acquire, during a process of executing power-on self-test on a server, a plurality of peripheral devices connected to the server, and memories of expanded memories of respective ones of the plurality of peripheral devices;
the first judgment unit 51 is configured to determine whether the memories of the expanded memories of the plurality of peripheral devices meet a preset memory condition of a basic input output system in the server, so as to obtain a determination result;
the first determination unit 52 is configured to determine a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and
the second determination unit 53 is configured to determine a target device sequence from among the plurality of candidate device sequences, and load and run the multiple target devices in the target device sequence.

As an exemplary implementation, in the device operation apparatus provided in the embodiments of the present disclosure, the memories of the expanded memories include running memories, when the determination result indicates that a total running memory of the expanded memories of the plurality of peripheral devices is greater than a first preset value, it is determined that the memories of the expanded memories of the plurality of peripheral devices do not meet the preset memory condition, wherein the first preset value refers to a size of a memory space supported by the basic input output system in the server.

As an exemplary implementation, in the device operation apparatus provided in the embodiments of the present disclosure, the memories of the expanded memories further include loading memories, and when the determination result indicates that a total running memory of the expanded memories of the plurality of peripheral devices is less than or equal to the first preset value, and the loading memory of a last peripheral device in a current arrangement order of the plurality of peripheral devices is greater than a second preset value, determining that the memories of the expanded memories of the plurality of peripheral devices do not meet the preset memory condition, wherein the first preset value refers to the size of the memory space supported by the basic input output system in the server, and the second preset value is less than the first preset value.

As an exemplary implementation, in the device operation apparatus provided in the embodiments of the present disclosure, the apparatus further includes: a first traversing unit, configured to traverse the memories of the expanded memories of the plurality of peripheral devices before determining whether the memories of the expanded memories of the plurality of peripheral devices meet the preset memory condition of the basic input output system in the server, so as to obtain the determination result, to obtain the running memories and the loading memories of respective ones of the plurality of peripheral devices; and a summing unit, configured to sum the running memories of the plurality of peripheral devices to obtain the total running memory of the expanded memories of the plurality of peripheral devices.

As an exemplary implementation, in the device operation apparatus provided in the embodiments of the present disclosure, the memories of the expanded memories include running memories, and when the determination result indicates that the total running memory of the expanded memories of the plurality of peripheral devices is greater than the first preset value, first alarm information is sent.

As an exemplary implementation, in the device operation apparatus provided in the embodiments of the present disclosure, the first determination unit 52 includes: a combining module, configured to combine at least two peripheral devices among the plurality of peripheral devices multiple times to obtain a plurality of combination results; a sequencing module, configured to arrange the devices in each of the plurality of combination results according to different orders, to obtain a plurality of initial device sequences; and a screening module, configured to screen the plurality of initial device sequences for at least one device sequence that meets a running rule, so as to obtain the candidate device sequences.

As an exemplary implementation, in the device operation apparatus provided in the embodiments of the present disclosure, the running rule includes at least one of the following: the candidate device sequence includes peripheral devices required for running of the server; the candidate device sequence includes peripheral device required by the server for executing a target service; a number of all the multiple target devices in the candidate device sequence is greater than a preset number; and a total running memory of all the multiple target devices in the candidate device sequence is less than or equal to a first preset value, wherein the first preset value refers to a size of a memory space supported by the basic input output system in the server.

As an exemplary implementation, in the device operation apparatus provided in the embodiments of the present disclosure, the second determination unit 53 includes: a calculation module, configured to respectively calculate a difference value between the first preset value and the total running memory of all the multiple target devices in each of the plurality of candidate device sequences, so as to obtain a plurality of remaining running memories; and a determination module, configured to determine a candidate device sequence with a maximum remaining running memory as the target device sequence.

As an exemplary implementation, in the device operation apparatus provided in the embodiments of the present disclosure, the apparatus further includes: a sending unit, configured to, after arranging the devices in each of the plurality of combination results according to different orders to obtain the plurality of initial device sequences, send second alarm information when there is no device sequence meeting the running rule in the plurality of initial device sequences.

As an exemplary implementation, in the device operation apparatus provided in the embodiments of the present disclosure, the apparatus further includes a second determination unit, configured to, before determining whether the memories of the expanded memories of the plurality of peripheral devices meet the preset memory condition of the basic input output system in the server to obtain a determination result, determine whether historical device information content check value stored in the basic input output system is 0, and determine whether a total device information content check value of the plurality of peripheral devices is the same as the historical device information content check value; a third determination unit, configured to load and run the target device when the historical device information content check value is not 0 and the total device information content check value of the plurality of peripheral devices is the same as the historical device information content check value; and an execution unit, configured to execute, when the historical device information content check value is 0 or the total device information content check value of the plurality of peripheral devices is different from the historical device information content check value, the operation of determining whether the memories of the expanded memories of the plurality of peripheral devices meet the preset memory condition of the basic input output system in the server.

As an exemplary implementation, in the device operation apparatus provided in the embodiments of the present disclosure, the apparatus further includes a second traversing unit, configured to traverse, before determining whether the total device information content check value of the plurality of peripheral devices is the same as the historical device information content check value, device information contents of the plurality of peripheral devices, and calculate a device information content check value according to the device information content of each of the plurality of peripheral devices, so as to obtain a plurality of device information content check values; and a summing unit, configured to sum the device information content check values of the plurality of peripheral devices to obtain the total device information content check value.

As an exemplary implementation, in the device operation apparatus provided in the embodiments of the present disclosure, the apparatus further includes a first reading unit, configured to, after determining whether the historical device information content check value stored in the basic input output system is 0, and determining whether the total device information content check value of the plurality of peripheral devices is the same as the historical device information content check value, and when the historical device information content check value is not 0 and the total device information content check value of the plurality of peripheral devices is the same as the historical device information content check value, read a historical device sequence stored in the basic input output system, wherein the historical device sequence is composed of multiple target devices according to a historical arrangement order; and a loading unit, configured to load and run the multiple target devices according to the historical device sequence.

As an exemplary implementation, in the device operation apparatus provided in the embodiments of the present disclosure, the apparatus further includes a second reading unit, configured to read, after determining whether the memories of the expanded memories of the plurality of peripheral devices meet a preset memory condition of a basic input output system in the server to obtain a determination result, and when the determination result indicates that the memories of the expansion memories of the plurality of peripheral devices meet the preset memory condition, read a device sequence stored in the basic input output system, and load and run the plurality of peripheral devices according to the stored device sequence.

As an exemplary implementation, in the device operation apparatus provided in the embodiments of the present disclosure, the second determination unit 53 includes: a summing module, configured to sum device information content check values of the multiple target devices to obtain an updated total device information content check value; a storage module, configured to store the target device sequence and the updated total device information content check value to the basic input output system; and a restart module, configured to restart the server, and load and run the multiple target devices in the server using the basic input output system.

It should be noted that the modules above may be implemented by software or hardware, and the latter may be implemented in the following manner, but is not limited thereto. All the modules above are located in the same processor; or all the modules above are located in different processors in any arbitrary combination manner.

An embodiment of the present disclosure further provides a non-volatile readable storage medium storing a computer program, wherein the computer program is configured to execute, when running, the operations in any one of the described method embodiments.

In an exemplary embodiment, the non-volatile readable storage medium may include, but is not limited to, any medium that may store a computer program, such as a USB flash drive, a Read-Only Memory (ROM), a Random Access Memory (RAM), a removable hard disk, a magnetic disk, or an optical disc.

An embodiment of the present disclosure also provides an electronic device, including a memory and a processor, wherein the memory stores a computer program, and the processor is configured to run the computer program to execute the operations in any one of the device operation method.

In an exemplary embodiment, the electronic device may further include a transmission device and an input/output device, wherein the transmission device is connected to the processor, and the input/output device is connected to the processor.

For optional examples in the present embodiment, reference may be made to the examples described in the described embodiments and exemplary embodiments, and thus they will not be repeated again in the present embodiment.

Obviously, those skilled in the art should understand that the modules or operations in the present disclosure may be implemented by using a general computing device, and they may be integrated in a single computing device, and may also be distributed over a network consisting of a plurality of computing devices. They may be implemented by using executable program codes of the computing devices. Thus, they may be stored in a storage device and executed by the computing devices. Furthermore, in some cases, the shown or described operations may be executed in an order different from that described here, or they may be respectively implemented by individual Integrated Circuit modules, or they may be implemented by making a plurality of the modules or operations into a single Integrated Circuit module. Hence, the present disclosure is not limited to any specific combinations of hardware and software.

The described content merely relates to optional embodiments of the present disclosure and is not intended to limit the present disclosure. For a person skilled in the art, the present disclosure may have various modifications and variations. Any modifications, equivalent replacements, improvements, etc., made within the principle of the present disclosure shall all belong to the scope of protection of the present disclosure.

1. A device operation method, comprising:
during a process of executing power-on self-test on a server, acquiring a plurality of peripheral devices connected to the server, and memories of expanded memories of respective ones of the plurality of peripheral devices;
determining whether the memories of the expanded memories of the plurality of peripheral devices meet a preset memory condition of a basic input output system in the server, so as to obtain a determination result;
determining a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and
determining a target device sequence from among the plurality of candidate device sequences, and loading and running the multiple target devices in the target device sequence.

2. The device operation method according to claim 1, wherein the memories of the expanded memories comprise running memories, when the determination result indicates that a total running memory of the expanded memories of the plurality of peripheral devices is greater than a first preset value, determining that the memories of the expanded memories of the plurality of peripheral devices do not meet the preset memory condition, wherein the first preset value refers to a size of a memory space supported by the basic input output system in the server.

3. The device operation method according to claim 2, wherein the memories of the expanded memories further comprise loading memories, and when the determination result indicates that a total running memory of the expanded memories of the plurality of peripheral devices is less than or equal to the first preset value, and the loading memory of a last peripheral device in a current arrangement order of the plurality of peripheral devices is greater than a second preset value, determining that the memories of the expanded memories of the plurality of peripheral devices do not meet the preset memory condition, wherein the first preset value refers to the size of the memory space supported by the basic input output system in the server, and the second preset value is less than the first preset value.

4. The device operation method according to claim 3, wherein before determining whether the memories of the expanded memories of the plurality of peripheral devices meet the preset memory condition of the basic input output system in the server, so as to obtain the determination result, the device operation method further comprises:
traversing the memories of the expanded memories of the plurality of peripheral devices, to obtain the running memories and the loading memories of respective ones of the plurality of peripheral devices; and
summing the running memories of the plurality of peripheral devices to obtain the total running memory of the expanded memories of the plurality of peripheral devices.

5. The device operation method according to claim 2, wherein the memories of the expanded memories comprise the running memories, and when the determination result indicates that the total running memory of the expanded memories of the plurality of peripheral devices is greater than the first preset value, first alarm information is sent.

6. The device operation method according to claim 1, wherein determining the plurality of candidate device sequences according to the plurality of peripheral devices when the determination result indicates that the memories of the expanded memories of the plurality of peripheral devices do not meet the preset memory condition comprises:
combining at least two peripheral devices among the plurality of peripheral devices multiple times to obtain a plurality of combination results;
arranging the devices in each of the plurality of combination results according to different orders, to obtain a plurality of initial device sequences; and
screening the plurality of initial device sequences for at least one device sequence that meets a running rule, so as to obtain the candidate device sequences.

7. The device operation method according to claim 6, wherein the running rule comprises at least one of the following:
the candidate device sequence comprises peripheral devices required for running of the server;
the candidate device sequence comprises peripheral device required by the server for executing a target service;
a number of all the multiple target devices in the candidate device sequence is greater than a preset number; and
a total running memory of all the multiple target devices in the candidate device sequence is less than or equal to a first preset value, wherein the first preset value refers to a size of a memory space supported by the basic input output system in the server.

8. The device operation method according to claim 7, wherein determining the target device sequence from among the plurality of candidate device sequences comprises:
respectively calculating a difference value between the first preset value and the total running memory of all the multiple target devices in each of the plurality of candidate device sequences, so as to obtain a plurality of remaining running memories; and
determining a candidate device sequence with a maximum remaining running memory as the target device sequence.

9. The device operation method according to claim 6, wherein after arranging the devices in each of the plurality of combination results according to different orders to obtain the plurality of initial device sequences, the device operation method further comprises:
when there is no device sequence meeting the running rule in the plurality of initial device sequences, sending second alarm information.

10. The device operation method according to claim 1, wherein before determining whether the memories of the expanded memories of the plurality of peripheral devices meet the preset memory condition of the basic input output system in the server, so as to obtain the determination result, the device operation method further comprises:
determining whether historical device information content check value stored in the basic input output system is 0, and determining whether a total device information content check value of the plurality of peripheral devices is the same as the historical device information content check value;
when the historical device information content check value is not 0 and the total device information content check value of the plurality of peripheral devices is the same as the historical device information content check value, loading and running the target device;
when the historical device information content check value is 0 or the total device information content check value of the plurality of peripheral devices is different from the historical device information content check value, executing the operation of determining whether the memories of the expanded memories of the plurality of peripheral devices meet the preset memory condition of the basic input output system in the server.

11. The device operation method according to claim 10, wherein before determining whether the total device information content check value of the plurality of peripheral devices is the same as the historical device information content check value, the device operation method further comprises:
traversing device information contents of the plurality of peripheral devices, and calculating a device information content check value according to the device information content of each of the plurality of peripheral devices, so as to obtain a plurality of device information content check values; and
summing the device information content check values of the plurality of peripheral devices to obtain the total device information content check value.

12. The device operation method according to claim 10, wherein after determining whether the historical device information content check value stored in the basic input output system is 0, and determining whether the total device information content check value of the plurality of peripheral devices is the same as the historical device information content check value, the device operation method further comprises:
when the historical device information content check value is not 0 and the total device information content check value of the plurality of peripheral devices is the same as the historical device information content check value, reading a historical device sequence stored in the basic input output system, wherein the historical device sequence is composed of multiple target devices according to a historical arrangement order; and
loading and running the multiple target devices according to the historical device sequence.

13. The device operation method according to claim 1, wherein after determining whether the memories of the expanded memories of the plurality of peripheral devices meet the preset memory condition of the basic input output system in the server, so as to obtain the determination result, the device operation method further comprises:
when the determination result indicates that the memories of the expansion memories of the plurality of peripheral devices meet the preset memory condition, reading a device sequence stored in the basic input output system, and loading and running the plurality of peripheral devices according to the stored device sequence.

14. The device operation method according to claim 1, wherein loading and running the multiple target devices in the target device sequence comprises:
summing device information content check values of the multiple target devices to obtain an updated total device information content check value;
storing the target device sequence and the updated total device information content check value to the basic input output system; and
restarting the server, and loading and running the multiple target devices in the server using the basic input output system.

15. A device operation system, comprising:
a server;
a plurality of peripheral devices connected to the server; and
a basic input output system, deployed in the server and configured to, during a process of executing power-on self-test on the server and when memories of expanded memories of a plurality of peripheral devices do not meet a preset memory condition, determine a plurality of candidate device sequences according to the plurality of peripheral devices, determine a target device sequence from among the plurality of candidate device sequences, and load and run multiple target devices in the target device sequence, wherein each of the plurality of candidate device sequences is composed of multiple target devices according to a preset arrangement order, and the multiple target devices are devices in the plurality of peripheral devices.

16. The device operation system according to claim 15, wherein the memories of the expanded memories comprise running memories, the basic input output system is configured to, when a total running memory of the expanded memories of the plurality of peripheral devices is greater than a first preset value, determine that the memories of the expanded memories of the plurality of peripheral devices do not meet the preset memory condition, wherein the first preset value refers to a size of a memory space supported by the basic input output system in the server.

17. The device operation system according to claim 15, wherein the memories of the expanded memories comprise running memories and loading memories, and the basic input output system is configured to, when a total running memory of the expanded memories of the plurality of peripheral devices is less than or equal to a first preset value, and the loading memory of a last peripheral device in a current arrangement order of the plurality of peripheral devices is greater than a second preset value, determine that the memories of the expanded memories of the plurality of peripheral devices do not meet the preset memory condition, wherein the first preset value refers to a size of a memory space supported by the basic input output system in the server, and the second preset value is less than the first preset value.

18. The device operation system according to claim 15, wherein the basic input output system is configured to determine the candidate device sequence by:
combining at least two peripheral devices among the plurality of peripheral devices multiple times to obtain a plurality of combination results;
arranging the devices in each of the plurality of combination results according to different orders, to obtain a plurality of initial device sequences; and
screening the plurality of initial device sequences for at least one device sequence that meets a running rule, so as to obtain the candidate device sequences.

19. (canceled)

20. A non-transitory non-volatile readable storage medium, wherein the non-transitory non-volatile readable storage medium stores a computer program, and when the computer program is executed by a processor, following operations are implemented:
during a process of executing power-on self-test on a server, acquiring a plurality of peripheral devices connected to the server, and memories of expanded memories of respective ones of the plurality of peripheral devices;
determining whether the memories of the expanded memories of the plurality of peripheral devices meet a preset memory condition of a basic input output system in the server, so as to obtain a determination result;
determining a plurality of candidate device sequences according to the plurality of peripheral devices when the determination result indicates that the memories of the expanded memories of the plurality of peripheral devices do not meet the preset memory condition, wherein each of the plurality of candidate device sequences is composed of multiple target devices according to a preset arrangement order, and the multiple target devices are devices in the plurality of peripheral devices; and
determining a target device sequence from among the plurality of candidate device sequences, and loading and running the multiple target devices in the target device sequence.

21. An electronic device, comprising a memory, a processor, and a computer program stored in the memory and runnable on the processor, wherein when executing the computer program, the processor implements operations of the device operation method according to claim 1.
